(19) United States
(12) Patent Application Publication
(10) Pub. No.: US 2025/0251001 A1
(43) Pub. Date: Aug. 7, 2025

(54) SCREW CONNECTION ARRANGEMENT

(71) Applicant: R&D Engineering A/S, Hinnerup (DK)

(72) Inventor: Flemming Selmer NIELSEN, Hammel (DK)

(21) Appl. No.: 19/045,149

(22) Filed: Feb. 4, 2025

(30) Foreign Application Priority Data
Feb. 5, 2024 (DE) 102024103142.5

(51) Int. Cl. F16B 5/02

(52) U.S. Cl. CPC F16B 5/02

(57) ABSTRACT

A screw connection assembly comprises a screw comprising a screw body with a screw shaft, which bears a threading, in particular an outer threading, at least in sections. The screw connection assembly can further comprise a screw nut serving and/or configured as a counterpart to the screw, which screw nut comprises a nut body having a threading corresponding to the threading of the screw shaft, in particular an inner threading, and which is or can be screwed onto the screw shaft. It can be provided in particular that the nut body of the screw nut at least partially or regionally bears a layer, in particular a coating, which tribologically increases a coefficient of friction between the nut body of the screw nut and a surface contacting the nut body of the screw nut in the assembled state of the screw connection assembly.

### CROSS-REFERENCE TO RELATED APPLICATION

The present application is based on and claims the benefit of German patent application Serial No. 10 2024 103 142.5, filed Feb. 5, 2024, the content of which is hereby incorporated by reference in its entirety.

### BACKGROUND

The present invention relates to a screw connection arrangement. The screw connection arrangement is particularly suitable for connecting components of large-scale plants, such as wind turbines, façade elements or offshore installations.

The screw connection arrangement comprises a screw and a nut serving and/or designed as a counterpart to the screw. The screw has a screw body with a screw shaft that is at least partially threaded, in particular externally threaded.

The screw nut serving and/or designed as a counterpart to the screw has a nut body with a thread, in particular an internal thread, corresponding to the thread of the screw shaft, and is screwed or can be screwed onto the screw shaft.

The term “screw” as used herein is to be generally understood as a fastener with external or internal threading intended for insertion through the holes in assembled parts and normally intended for tightening or loosening by tightening a nut.

In particular, a screw as defined by the present invention is a cylindrical or slightly tapered (conical) body, in the surface of which a thread (external thread) is preferably cut or rolled. A connection made with a screw is usually reversible and detachable.

A “nut” within the meaning of the present invention is to be understood as the corresponding counterpart of a screw, which is provided with an internal or external thread.

Bolt assemblies with a screw and a nut are used in a variety of applications to connect components in a detachable manner. Bolt assemblies are usually provided with washers that have disk bodies and are or can be pushed onto the bolt shaft.

Washers are ring-shaped, usually metal disks that can be placed over the shaft of a screw. When placed between the head of a screw and the part to which it is attached, a washer is used to transfer the force exerted by the underside of the screw head over a larger area of the part, the material of which is usually less strong than that of the screw. With full-length metal screws, a washer is also placed under the nut.

Due to its larger diameter, the washer remains on the part to be fastened when the screw or nut is tightened. The sliding occurs between the screw head or nut and the surface of the part, and the surface of the part cannot be damaged by rubbing.

Generally, a problem exists in that, as a rule, two tools are needed to assemble a screw connection arrangement, namely a first tool that is designed to fit the screw head of the screw, and a second tool that is designed to fit the nut of the screw connection arrangement. These two tools are held accordingly, which is usually done manually, while one tool is turned relative to the other, thus screwing the nut onto the screw shaft of the screw and thus fixing the screw in place.

However, screw connection arrangements often have to be provided in areas that cannot be reached, or only with difficulty and using appropriate tools.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in deter-mining the scope of the claimed subject matter. The claimed subject matter is not limited to implementations that solve any or all disadvantages noted in the Background.

An aspect of the invention is based on the task of further developing a screw connection arrangement of the type mentioned at the beginning in such a way that it can be mounted in a manner that is easy to implement, in particular in areas that are difficult to access.

In addition, the screw connection arrangement should still be securely and reliably fixable.

According to one aspect of the present invention, the underlying problem is solved by a screw connection arrangement which has a screw and a screw nut serving and/or formed as a counterpart to the screw, wherein the screw has a screw body with a screw shank which is provided at least in sections with a thread, in particular an external thread. The screw nut serving and/or designed as a counterpart to the screw has a nut body with a thread corresponding to the thread of the screw shaft, in particular an internal thread, and is screwed or can be screwed onto the screw shaft.

According to the first aspect of the present invention, it is envisaged that the nut body of the screw nut is provided, at least partially or in some areas, with a layer, in particular a coating, which tribologically increases a friction coefficient between the nut body of the screw nut and a surface coming into contact with the nut body of the screw nut in the assembled state of the screw connection arrangement, wherein, in one embodiment, a mean thickness of the layer is in a range between about 150 μm and about 3 μm.

According to a further aspect, the problem underlying the invention is solved by a screw connection arrangement with a screw and a screw nut serving and/or designed as a counterpart to the screw, wherein the screw connection arrangement further comprises at least one washer, and in one embodiment, preferably two washers, which comprise a washer body, and are pushed or can be pushed onto the screw shaft of the screw body.

In the case of the second aspect of the present invention, it is in particular envisaged that the disc body of the at least one washer which comes into contact with the nut body of the screw nut in the assembled state of the screw connection arrangement, and/or a surface of the nut body of the screw nut which comes into contact with the disc body of the at least one washer in the assembled state of the screw connection arrangement, body of the at least one washer comes into contact, is provided, at least in part or in some areas, with a layer, in particular a coating, which tribologically increases a coefficient of friction between the nut body and the disc body of the at least one washer, wherein a mean thickness of the layer, in one embodiment, is in a range between about 150 μm and about 3 μm.

According to further developments or variants of the second aspect of the invention, it is envisaged that the screw body of the screw is intended for at least partial or regional insertion into a through-hole in at least one component.

In one design variant, it is provided that the disc body of the at least one washer that comes into contact with the nut body of the screw nut when the screw connection arrangement is assembled is provided, at least partially or in some areas, with a layer, in particular a coating, which tribologically increases a coefficient of friction between the disc body of the at least one washer and the component, wherein a mean thickness of the layer, in one embodiment, is in a range between about 150 μm and about 3 μm.

Alternatively or in addition to this design variant, it is envisaged that the screw will have a screw head.

In an embodiment, it is provided in particular that the disc body of the at least one washer that comes into contact with the screw head of the screw in the assembled state of the screw connection arrangement is provided, at least partially or in some areas, with a layer, in particular a coating, which in a tribological manner increases a coefficient of friction between the screw head and the disc body of the at least one washer, wherein a mean thickness of the layer in one embodiment lies in a range between about 150 μm and about 3 μm.

Alternatively or in addition to this, it is also conceivable that the screw head of the screw is provided, at least partially or in some areas, with a layer, in particular a coating, which tribologically increases a coefficient of friction between the screw head of the screw and a surface coming into contact with the screw head of the screw in the assembled state of the screw connection arrangement, wherein a mean thickness of the layer in one embodiment is in a range between about 150 μm and about 3 μm.

According to yet another embodiment of the screw connection arrangement, it is envisaged that the screw body of the screw is intended for at least partial or regional insertion into a through-hole in at least one component, wherein, furthermore, the screw has a screw head.

In this context, it is specifically provided that the disk body of the at least one washer that comes into contact with the screw head of the screw in the assembled state of the screw connection arrangement is provided, at least partially or in some areas, with a layer, in particular a coating, which increases a coefficient of friction between the component and the disc body of the at least one washer in a tribological manner, wherein a mean thickness of the layer in one embodiment is in a range between about 150 μm and about 3 μm.

All the aforementioned embodiments of the present invention have in common the use of a novel tribological system with which a coefficient of friction between a component of the screw connection arrangement, such as the body of the screw nut, the washers, the surface of the component or the screw head, is deliberately increased.

The layer of the tribological system thus takes on the role of an abradant, which is the opposite of a lubricant. In other words, instead of the lubrication that is usually desired and required between two components, the use of a means of increasing friction is provided between two components of the screw connection arrangement (“friction partners”) that move relative to each other at least when the screw connection arrangement is assembled.

The layer, which is designed in particular as a coating and in particular as a tribological system, is designed in particular to increase the coefficient of friction between the components moving relative to one another when the screw connection arrangement is assembled by at least about 100%, preferably by at least about 150% and more preferably by about 200% to about 300%.

This measure considerably simplifies the assembly of the screw connection arrangement, since the screw nut that serves and/or is designed as a counterpart to the screw does not have to be held, or only with a reduced amount of force, when the screw connection arrangement is assembled, i.e. when it is screwed onto the screw shaft of the screw body.

For the realization of the layer, which is designed in particular as a coating and in particular as a tribological system, it is intended that it has at least one abrasive that serves in particular as an abradant.

The abrasive, which is used in particular as an abradant, may comprise hard material grains based on natural grain materials and/or hard material grains based on synthetic grain materials. In particular, grain materials made of flint, quartz, corundum, lubricating gel, garnet or grain materials based on tungsten carbides, nickel carbides, silicon carbide, chromium oxide, (cubic) boron nitride, aluminum oxide and/or diamond are suitable here.

The layer serving as a tribological system can be designed as a powder, as a paste, in particular a grinding paste, or as a matrix system, in particular based on epoxy. In this context, it is particularly useful for the layer designed as a tribological system to be formed as a composite material embedded in a matrix.

Preferably, the abrasive, which is designed as a tribological system, can be applied to components of the screw connection arrangement at a later stage. It is conceivable, for example, that the layer applied is or can be applied by dip-spinning, spraying, dip-drawing and/or brushing on.

According to preferred embodiments of the screw connection arrangement, the bolt body and/or the disc body of the at least one disc and/or the nut body are made of metal, in particular steel, preferably high-alloy steel, brass, aluminum and/or copper.

In particular, the screw head of the screw has a rotary drive with a contour of surfaces that is designed to fit a positive fit with a tool designed such as but not limited to a screwdriver, wrench or bit as is well known.

In the same way, the screw nut should have a rotary drive with a contour of surfaces that is designed to form a positive fit with a tool, such as but not limited to a screwdriver, wrench or bit as is well known.

The present invention also relates to a system with at least one component in which a passage, in particular a through-hole, is formed, and with a screw connection arrangement of the aforementioned type, wherein the screw body of the screw of the screw connection arrangement is inserted at least partially or in some areas into the passage.

The component is made of metal, in particular steel, preferably high-alloy steel, brass, aluminum and/or copper, although composite materials, in particular plastic composite materials, are also conceivable.

Finally, another aspect of the invention relates to a composition, in particular in the form of a powder or in the form of a paste, which is designed as a tribological system for increasing a coefficient of friction between components of a screw connection arrangement of the aforementioned and/or for increasing a coefficient of friction between at least one component of a screw connection arrangement of the aforementioned type and a component.

In particular, the composition comprises at least one abrasive agent that serves as an abrasive, wherein the abrasive agent comprises hard material grains based on natural or synthetic grain materials.

According to a further aspect of the invention, the invention relates to a screw connection arrangement which has only one screw that has a screw body with a screw shaft that is provided at least in sections with a thread, in particular an external thread, wherein it is provided that the screw and in particular a screw head of the screw, the screw shaft and/or the screw shaft is provided, at least in part or in certain regions, with the previously described layer, in particular coating, which tribologically increases a coefficient of friction between the screw and a surface that comes into contact with the screw in the assembled state of the screw connection arrangement, wherein an average thickness of the layer in on embodiment is in the range of about 150 μm to about 3 μm.

### BRIEF DESCRIPTION OF THE DRAWINGS

In the following, an exemplary embodiment of the invention is described in more detail with reference to the accompanying drawing.

FIG. 1 is a sectional view of an exemplary embodiment of the screw connection arrangement in an assembled state.

### DETAILED DESCRIPTION OF ILLUSTRATIVE EMBODIMENTS

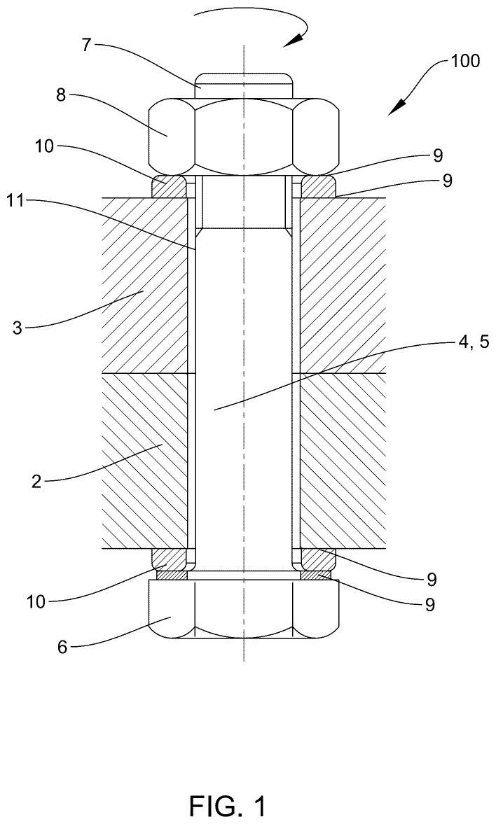

FIG. 1 shows an exemplary embodiment of the system 100. The 100 system includes two components 2, 3 that are to be connected to each other and in which a through-hole 11 is formed.

A screw connection arrangement is used to connect components 2 and 3.

The screw connection arrangement has a screw 4, which has a screw body with a screw shaft 5 that is partially provided with an external thread 7.

The screw connection arrangement also has a screw nut which serves and/or is designed as a counterpart to the screw 4, which has a nut body 8 with an internal screw thread corresponding to threads on the screw shaft 5 and which is screwed onto the screw shaft 5 of the screw 4.

The screw connection arrangement further comprises two washers, each having a washer body 10 and being slid on the screw shaft 5 of the screw body.

In this case, a first washer is arranged between a screw head of screw 4 and a first of the two components to be connected, while the second washer is arranged between the nut body 8 of the screw nut serving as a counterpart to screw 4 and the second component 3.

The screw connection arrangement, as used in the exemplary embodiment of the system 100 shown in FIG. 1, is characterized in particular by a tribological system for increasing a friction coefficient between the bolt head 6 of the bolt 4 and the washer, which comes into contact with the nut body 8 of the nut in the assembled state of the screw connection arrangement shown.

The tribological system is designed as a layer 9, in particular a coating, which tribologically increases the coefficient of friction between the washer body 10 of the washer and the screw head 6 of the screw 4.

In addition, in the exemplary embodiment of the system 100 shown in FIG. 1, a layer 9 that acts in a tribological manner is provided between the disc body 10 of the washer associated with the screw head 6 of the screw 4 and the component in order to increase the coefficient of friction.

Layer 9 is designed in particular as a coating and increases the corresponding coefficient of friction by about 200% to about 300%. For this purpose, layer 9, which serves in particular as a tribological system, has at least one abrasive serving as an abradant.

The abrasive used in abrasive blasting is primarily hard grains based on natural or synthetic grain materials, in particular tungsten carbide, nickel carbide and/or silicon carbide.

In this context, it is conceivable that the tribologically serving layer 9 is applied as a coating to the corresponding components.

It is conceivable, for example, that layer 9 is designed as a powder, as a paste, in particular a grinding paste, or as a matrix system, in particular an epoxy-based one.

The layer 9, which is particularly designed as a coating, can be applied to the corresponding components of the screw connection arrangement, at least in some areas, by such as but not limited to dipping, spraying, dipping and drawing and/or brushing on.

It can also be seen that the screw head 6 of the screw 4 has a rotary drive with a contour of surfaces that is designed to fit a positive fit with a tool designed in particular as a wrench or a bit.

In the same way, the screw nut has a rotary drive with a contour of surfaces that is designed to fit a positive fit with a tool designed in particular as a wrench or bit.

The invention is not limited to the exemplary embodiment shown in FIG. 1, but rather results from an overview of all features disclosed herein.

Although the present invention has been described with reference to preferred embodiments, workers skilled in the art will recognize that changes may be made in form and detail without departing from the spirit and scope of the invention.

What is claimed is:

1. A screw connection assembly, comprising a screw comprising a screw body with a screw shaft, which bears a threading, at least in sections, wherein a portion of the screw, the screw shaft, and/or the threading of the screw shaft at least partially or regionally bears a layer, which tribologically increases a coefficient of friction between the screw and a surface contacting the screw in an assembled state of the screw connection assembly, wherein an average thickness of the layer is in a range between about 150 μm and about 3 μm.

2. The screw connection assembly according to claim 1, wherein the screw connection assembly further comprises a screw nut serving and/or configured as a counterpart to the screw, which screw nut comprises a nut body having a threading corresponding to the threading of the screw shaft, and which is or can be screwed onto the screw shaft, wherein the nut body of the screw nut at least partially or regionally bears a layer, which tribologically increases a coefficient of friction between the nut body of the screw nut and a surface contacting the nut body of the screw nut in the assembled state of the screw connection assembly, wherein an average thickness of the layer is in a range between about 150 μm and about 3 μm.

3. The screw connection assembly according to claim 2, wherein the screw connection assembly further comprises at least one washer, which has a washer body and is configured to be pushed onto the screw shaft of the screw body, wherein the washer body of the at least one washer which comes into contact with the nut body of the screw nut in the assembled state of the screw connection assembly, and/or a surface of the nut body of the screw nut which comes into contact with the washer body of the at least one washer in the assembled state of the screw connection assembly, at least partially or regionally bears a layer, which tribologically increases a coefficient of friction between the nut body and the washer body of the at least one washer, wherein an average thickness of the layer is in a range between about 150 μm and about 3 μm.

4. The screw connection assembly according to claim 3, wherein the screw body of the screw is intended for at least partial or regional insertion into a through-hole into at least one component, wherein the washer body of the at least one washer which comes into contact with the nut body of the screw nut in the assembled state of the screw connection assembly at least partially or regionally bears a layer, which tribologically increases a coefficient of friction between the washer body of the at least one washer and the component, wherein an average thickness of the layer is in a range between about 150 μm and about 3 μm.

5. The screw connection assembly according to claim 3, wherein the screw comprises a screw head, wherein the washer body of the at least one washer which comes into contact with the screw head of the screw in the assembled state of the screw connection assembly at least partially or regionally bears a layer, which tribologically increases a coefficient of friction between the screw head and the washer body of the at least one washer, wherein an average thickness of the layer is in a range between about 150 μm and about 3 μm.

6. The screw connection assembly according to claim 1, wherein the screw comprises a screw head, wherein the screw head of the screw at least partially or regionally bears a layer, which tribologically increases a coefficient of friction between the screw head of the screw and a surface contacting the screw head of the screw in the assembled state of the screw connection assembly, wherein an average thickness of the layer is in a range between about 150 μm and about 3 μm.

7. The screw connection assembly according to claim 3, wherein the screw body of the screw is intended for at least partial or regional insertion into a through-hole into at least one component, and wherein the screw comprises a screw head, wherein the washer body of the at least one washer which comes into contact with the screw head of the screw in the assembled state of the screw connection assembly at least partially or regionally bears a layer, which tribologically increases a coefficient of friction between the component and the washer body of the at least one washer, wherein an average thickness of the layer is in a range between about 150 μm and about 3 μm.

8. The screw connection assembly according to claim 3, wherein the screw head of the screw comprises a rotary drive having a contour, which is configured so as to be suitable for forming a positive lock with a tool.

9. The screw connection assembly according to claim 2, wherein the screw nut comprises a rotary drive having a contour, which is configured so as to be suitable for forming a positive lock with a tool.

10. The screw connection assembly according to claim 2, wherein the layer, which is configured is configured so as to increase the coefficient of friction by at least about 100%, preferably by at least about 150%, and more preferably by about 200% to about 300%.

11. The screw connection assembly according to claim 1, wherein the layer comprises at least one abrasive.

12. The screw connection assembly according to claim 11, wherein the abrasive is made of hard material grains based on natural grain materials.

13. The screw connection assembly according to claim 1, wherein the layer is configured as a powder or as a paste.

14. The screw connection assembly according to claim 1, wherein the layer is formed as a composite material embedded in a matrix.

15. The screw connection assembly according to claim 1, wherein the layer is applied by plunge spinning, syringing, plunge drawing, and/or brushing.

16. The screw connection assembly according to claim 1, wherein the screw body and/or the washer body of the at least one washer and/or the nut body consists of metal.

17. A system comprising at least one component in which a passageway is formed and a screw connection assembly comprising a screw having a screw body with a screw shaft, which bears a threading at least in sections, wherein a portion of the screw, the screw shaft, and/or the threading of the screw shaft at least partially or regionally bears a layer, which tribologically increases a coefficient of friction between the screw and a surface contacting the screw in the assembled state of the screw connection assembly, wherein an average thickness of the layer is in a range between about 150 μm and about 3 μm, and wherein the screw body of the screw is inserted at least partially or regionally in the through-hole.

18. The system according to claim 17, wherein the component consists of metal.

19. A composition, which is configured as a tribological system for increasing a coefficient of friction between components of a screw connection assembly comprising a screw comprising a screw body with a screw shaft, which bears a threading, at least in sections, wherein a portion of the screw, the screw shaft, and/or the threading of the screw shaft at least partially or regionally.

20. The composition according to claim 19, wherein the composition comprises at least one abrasive serving as an abradant, wherein the at least one abrasive is made of hard material grains based on natural grain materials.
